(19) United States
(12) Patent Application Publication
(10) Pub. No.: US 2026/0011255 A1
(43) Pub. Date: Jan. 8, 2026

(54) SCHEMATIC INTERACTIONS VISUALIZATION SYSTEM FOR INNOVATIVE EDUCATION

(71) Applicant: XIANG ZHANG, GUANGZHOU (CN)

(72) Inventors: XIANG ZHANG, GUANGZHOU (CN); YE ZHOU, GUANGZHOU (CN); ZHICHENG PAN, GUANGZHOU (CN); FENG CUI, GUANGZHOU (CN)

(73) Assignee: XIANG ZHANG, GUANGZHOU (CN)

(21) Appl. No.: 18/923,632

(22) Filed: Oct. 22, 2024

(30) Foreign Application Priority Data
Jul. 8, 2024 (CN) 2024109045035

(51) Int. Cl. G09B 5/00; G06Q 50/20

(52) U.S. Cl. CPC G09B 5/00; G06Q 50/20

(57) ABSTRACT

Provided is a schematic interactions visualization (SIV) system for innovative education, which relates to the technical field of innovative education. The key points includes six key technologies: a spatial acoustic medicine technology, a course exploration technology of cross-disciplinary theme extraction for discipline bottlenecks, a SIV cross-disciplinary model design based on projects, a SIV course design technology for interactions strategy of disciplinary schemata, a SIV strategy of technology design for critical interactions events, and an evaluation technology design for individual works of thematic-concept-map.

### TECHNICAL FIELD

The present disclosure relates to the technical field of innovative education, and particularly to a schematic interactions visualization system for innovative education.

### BACKGROUND

At present, the application of educational technology at the interactive level mainly tends to be result-oriented, which ignores the value points output by brain science in personalized cognitive process. When generating creativity and advanced imagination, our brain needs to be immersed in sufficient divergent thinking for a period. Existing teaching in university education mainly adopts a linear thinking approach, which does not provide sufficient creativity spatiotemporal (i.e., spatial and temporal) interaction between teachers and students, and is no longer applicable to the current demand for innovative talents due to social changes. The domestic smart education platforms have obvious advantages in supporting the acquisition of learning content, teacher training, and enhancing students' thinking. However, there is no theoretical support for presentation of the integration of industry and education in cross-disciplinary innovative design. According to the China National Knowledge Internet (CNKI) database and the official website of the China Patent Office in May 2024, there is no patent for designing learning space, making many design concepts only at the level of discussion and speculation. How to design a learning space technology that conforms to the law of cognitive education in brain science and is easy to be transformed into practical action, so as to promote the efficient implementation of application strategies for smart education in learning spaces? The present disclosure starts from a new perspective of a deep integration design for information technology and disciplinary bottlenecks, and uses schematic interactions visualization to explore the efficient effectiveness of the system under this design thinking.

The schematic interactions visualization (SIV) system is a learning design theory and a method refined by the inventor through more than 20 years of cross-disciplinary teaching practice, which has carried out innovative teaching practice with obvious results in English reading, science of acupuncture and moxibustion, obstetrics, botany, ideological and political courses. SIV technology is not only a new innovative educational technology, but also an innovative teaching method. Considering the deep integration design of information technology and breakthroughs in discipline bottlenecks, starting from intelligently learning the spatial acoustic medicine technology, following the cognitive development laws of brain science, and from the aspects of attention, memory, emotion, motivation, and etc. closely related to learning, teachers and students are encouraged to engage in real interactive educational projects that are more creative, emotional, and artistic. In this way, the implicit disciplinary thinking can be effectively decoded and explicit through orderly schematic interactions activities. Thus, while promoting teaching innovation, cross-border integration of teaching and learning, stress reduction and efficiency improvement, and innovative memory are also achieved. And while achieving the teaching effect that a personalized cognitive process is evaluated by a sequence of trace, it also helps to develop a discipline education technology product that is guided and supported by discipline thinking characteristics, so that discipline education is the educational technology support with discipline specific characteristics rather than one-size-fits-all. In view of this, the inventor proposes a schematic interactions visualization system for innovative education.

### SUMMARY

In view of this, the present disclosure aims to provide a schematic interactions visualization system for innovative education, to alleviate the above technical problems.

The above technical purpose of the present disclosure is achieved through the following technical solution. A schematic interactions visualization system for innovative education, includes S1 to S6:

S1, a spatial acoustic medicine technology, which is configured to influence inner five elements of a human body by outer five elements under a space magnetic field generated through sound wave technology, and based on a physical energy intervention method which causes resonance (increasing amplitude) and harmonic oscillation (a relationship between harmonious waves and waves) between sound pressure waves and internal biological waves in the human body, boost a spatial energy field and provide a harmonious magnetic field in learning environment, thereby enhancing brain power and helping to effectively achieve interaction between teaching and learning;

S2, a course exploration technology of cross-disciplinary theme extraction for discipline bottlenecks, which is configured for a teacher to conduct a project-based interview with teachers from different discipline areas and professionals in related industries, so as to construct disciplinary map and to be concrete, to find out a list of discipline bottlenecks that are difficult for students to overcome and appear in teaching core concepts of disciplines, identify what discipline knowledge is involved in a cross-disciplinary topic course for the discipline bottlenecks, what discipline knowledge has become prerequisite knowledge through what single discipline course and what discipline knowledge must be learned through a cross-disciplinary course, what cross-disciplinary topic is able to be absorbed into a discipline course and what cross-disciplinary topic must be placed within the cross-disciplinary course, and what cross-disciplinary topic requires a plurality of single discipline courses and the cross-disciplinary course to complete spiral learning;

S3, a SIV cross-disciplinary model design based on projects, which is configured for teachers to construct a SIV cross-disciplinary model based on projects that is needed for students to master the discipline bottlenecks, provide a solution for an educational information technology teaching model oriented to serving discipline thinking and supported by a research method used to break through teaching bottlenecks, and generate technical approaches for innovative thinking abilities to solve the discipline bottlenecks; wherein a functional design and an adaptive design are included in the model, the functional design is relatively macroscopic and unchanging, and the adaptive design is relatively microscopic and needs to be adjusted according to an actual situation; and the teacher adapts himself into a course based on the functional design, thereby generating and implementing a practical and feasible personalized private course;

S4, a SIV course design technology for interactions strategy of disciplinary schemata, which is configured to: digitize a course content development process; use a technology of thematic-concept-map to provide support for teachers and students to integrate, through interactive expansion, learning resources and SIV teaching strategies before, during and after class, and draw learning resources of a students' thematic-concept-map for topic, a teachers' thematic-concept-map, and a students' expansion-thematic-concept-map that revolve around a core concept of the discipline bottlenecks; construct a learning field for interaction to achieve precise, deep, and extended discipline learning, thereby cultivating and enhancing discipline schematic thinking innovation ability of the students; and return, based on a 5P bead model, to the learning field to solve a problem of discipline innovation;

S5, a SIV strategy of technology design for critical interactions events, which is configured to perform module format on an educational process, and calculate a consistency level between a design state and an operating state of an education system, wherein modules must be reusable and loosely coupled to avoid a change in one module from affecting multiple modules; determined by adopting a combination of qualitative and quantitative evaluation module of critical interactions events, learners' abilities to achieve learning outcomes are evaluated. Thus improving the project-based model design for the SIV cross-disciplinary theme;

S6, an evaluation technology design for individual works of thematic-concept-map, which is configured to take, through a series of educational activities, students' personalized work from a flat map to a spatiotemporal four-dimensional design work, wherein the works of thematic-concept-map include presentation of the thematic-concept-map before class, educational drama interpretation of the thematic-concept-map during class, and presentation of discipline micro movies video work of the thematic-concept-map after class, and follow a rule of memory from a sensory memory input by external five senses to a first-order storage, a second-order storage and a third-order storage that lasts a lifetime. The multi-dimensional and orderly presentation and evaluation of the works effectively enhance high-level thinking abilities of teachers and students in various disciplines.

In the disclosure, the 5P bead model in S4 includes phenomenon, problem, plan, prototype, and promotion.

In the disclosure, the learning field in S4 integrates acoustic medicine, cognition, emotion, and action.

In summary, the present disclosure has the following beneficial effects. First, the discipline bottlenecks are effectively extracted quickly, precisely, and accurately, and a discipline bottleneck formula is extracted in a visualization manner. Second, through a series of orderly reflective schema interaction activities, an improvement in discipline high-quality thinking ability is achieved based on cognitive laws, meanwhile, the memory is innovated. Third, the interdisciplinary thinking ability of teachers and students to solve complex disciplinary problems under project design is effectively cultivated, thereby achieving the technology research and development of characteristic education based on disciplinary orientation, and achieving the organic integration of industry, teaching, scientific research, and talent cultivation.

### BRIEF DESCRIPTION OF DRAWINGS

FIG. 1 is a schematic diagram illustrating a roadmap of schematic interactions visualization (SIV) technology provided by the present disclosure.

### DETAILED DESCRIPTION OF EMBODIMENTS

The technical solutions in the examples of the present disclosure will be clearly and comprehensively described below in conjunction with drawings in the examples of the present disclosure. Apparently, the described examples are only a part rather than all of the examples of the present disclosure. Based on the examples of the present disclosure, all other examples, obtained by those skilled in the art based on the examples in the present disclosure without making any creative labor, shall fall within the scope of protection of the present disclosure.

### EXAMPLES

A schematic interactions visualization (SIV) system for innovative education is provided. The SIV technology aims to break through discipline bottlenecks with a cross-disciplinary topic model, and enhance the high-level thinking abilities of teachers and students. From the spatial acoustic medicine technology, the course exploration technology of cross-disciplinary theme extraction for discipline bottlenecks, the SIV cross-disciplinary model design based on projects, the SIV course design technology for interactions strategy of disciplinary schemata, the SIV strategy technology design for critical interactions events, and the evaluation design technology for individual works of thematic-concept-map, an education technology design that organically integrates teaching, research, industry, and talent cultivation which are all linked with one another is established. A series of effective teaching and learning interaction strategies based on the deep multidisciplinary fusion of SIV technology and discipline thinking are constructed, achieving efficient guidance for teachers and students to achieve personalized and evidence-based subject thinking in different teaching scenarios.

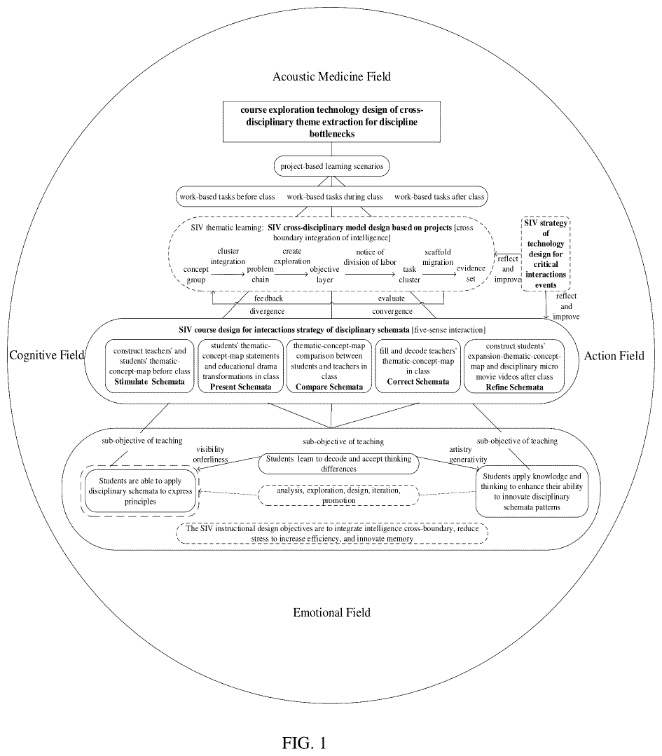

As shown in FIG. 1, the SIV system for innovative education includes:

S1, a spatial acoustic medicine technology, which is configured to influence inner five elements of the human body by outer five elements under a built spatial field acoustic technology, and based on a physical energy intervention method which causes resonance (increasing amplitude) and harmonic oscillation (a relationship between harmonious waves and waves) between sound pressure waves and internal biological waves in the human body, boost a spatial energy field and provide a harmonious magnetic field in learning environment, thereby enhancing brain power and helping to effectively achieve interaction between teaching and learning;

S2, a course exploration technology of cross-disciplinary theme extraction for discipline bottlenecks, which is configured for a teacher to conduct a project-based interview with teachers from different discipline areas and professionals in related industries, so as to construct disciplinary map and to be concrete, to find out a list of discipline bottlenecks that are difficult for students to overcome and appear in teaching core concepts of disciplines, identify what discipline knowledge is involved in a cross-disciplinary topic course for the discipline bottlenecks, what discipline knowledge has become prerequisite knowledge through what single discipline course and what discipline knowledge must be learned through a cross-disciplinary course, what cross-disciplinary topic is able to be absorbed into a discipline course and what cross-disciplinary topic must be placed within the cross-disciplinary course, and what cross-disciplinary topic requires a plurality of single discipline courses and the cross-disciplinary course to complete spiral learning;

S3, a SIV cross-disciplinary model design based on projects, which is configured for teachers to construct a SIV cross-disciplinary model based on projects that is needed for students to master the discipline bottlenecks, provide a solution for an educational information technology teaching model oriented to serving discipline thinking and supported by a research method used to break through teaching bottlenecks, and generate technical approaches for innovative thinking abilities to solve the discipline bottlenecks. A functional design and an adaptive design are included in the model, the functional design is relatively macroscopic and unchanging, and the adaptive design is relatively microscopic and needs to be adjusted according to an actual situation; and the teacher adapts himself into a course based on the functional design, thereby generating and implementing a practical and feasible personalized private course;

S4, a SIV course design technology for interactions strategy of disciplinary schemata, which is configured to: use a technology of thematic-concept-map to provide support for teachers and students to integrate, through interactive expansion, learning resources and SIV teaching strategies before, during and after class, and draw learning resources of a students' thematic-concept-map, a teachers' thematic-concept-map, and a students' expansion-thematic-concept-map that revolve around a core concept of the discipline bottlenecks; construct a learning field for interaction to achieve precise, deep, and extended discipline learning, thereby cultivating and enhancing discipline schematic thinking innovation ability of the students. And then, through a 5P bead model, that is, phenomenon analysis (phenomenon), problem exploration (problem), plan design (plan), prototype iteration (prototype) and value promotion (promotion), a learning field is returned to solve a problem of discipline innovation. The learning content is oriented to concepts and skills in the learning context. The evaluation is based on the combination of learning outcomes and the ability practice test of the learning process, as well as peer evaluation. The learning style embodies the characteristics of openness, diversity, immersion, and interaction. The learning guidance accompanies the growth and changes of learners, creating a contextualized, on-demand, self-directed, and technologically customized learning environment that innovates and leverages power;

S5, a SIV strategy of technology design for critical interactions events, which is configured to perform module format on an educational process, and calculate a consistency level between a design state and an operating state of an education system, where modules must be reusable and loosely coupled to avoid a change in one module from affecting multiple modules; determined, by adopting a combination of qualitative and quantitative evaluation module of critical interactions events, learners' abilities to achieve learning outcomes are evaluated. Thus improving the project-based model design for the SIV cross-disciplinary theme;

S6, an evaluation technology design for individual works of thematic-concept-map, which is configured to take, through a series of educational activities, students' personalized work from a flat map to a spatiotemporal four-dimensional design work. The works of thematic-concept-map include presentation of the thematic-concept-map before class, educational drama interpretation of the thematic-concept-map during class, and presentation of discipline micro movies video work of the thematic-concept-map after class, and follows a rule of memory from a sensory memory input by external five senses to a first-order storage, a second-order storage and a third-order storage that lasts a lifetime; wherein multi-dimensional and orderly presentation and evaluation of the works effectively enhance high-level thinking abilities of teachers and students in various disciplines

In some implementations, the 5P bead model in S4 includes phenomenon, problem, plan, prototype, and promotion.

In some implementations, the learning field in S4 integrates acoustic medicine, cognition, emotion, and action, and has visibility, orderliness, artistry, and generativity.

Finally, it should be noted that the above description is only some preferred examples of the present disclosure, and not to limit the present disclosure. Although the present disclosure have been described in detail with reference to the aforementioned examples, those skilled in the art should understand that they can still modify the technical solutions described in the aforementioned examples, or equivalently replace some of the technical features therein. These modifications, equivalent substitutions or improvements within the essence and scope of the present disclosure, shall fall within the scope of protection of the present disclosure.

What is claimed is:

1. A schematic interactions visualization (SIV) system for innovative education, comprising:
S1, a spatial acoustic medicine technology, which is configured to influence inner five elements of a human body by outer five elements under a space magnetic field generated through sound wave technology, and based on a physical energy intervention method which causes resonance and harmonic oscillation between sound pressure waves and internal biological waves in the human body, boost a spatial energy field and provide a harmonious magnetic field in learning environment, thereby enhancing brain power and helping to effectively achieve interaction between teaching and learning;
S2, a course exploration technology of cross-disciplinary theme extraction for discipline bottlenecks, which is configured for a teacher to conduct a project-based interview with teachers from different discipline areas and professionals in related industries, so as to construct disciplinary map and to be concrete, to find out a list of discipline bottlenecks that are difficult for students to overcome and appear in teaching core concepts of disciplines, identify what discipline knowledge is involved in a cross-disciplinary topic course for the discipline bottlenecks, what discipline knowledge has become prerequisite knowledge through what single discipline course and what discipline knowledge must be learned through a cross-disciplinary course, what cross-disciplinary topic is able to be absorbed into a discipline course and what cross-disciplinary topic must be placed within the cross-disciplinary course, and what cross-disciplinary topic requires a plurality of single discipline courses and the cross-disciplinary course to complete spiral learning;
S3, a SIV cross-disciplinary model design based on projects, which is configured for teachers to construct a SIV cross-disciplinary model based on projects that is needed for students to master the discipline bottlenecks, provide a solution for an educational information technology teaching model oriented to serving discipline thinking and supported by a research method used to break through teaching bottlenecks, and generate technical approaches for innovative thinking abilities to solve the discipline bottlenecks; wherein a functional design and an adaptive design are included in the model, the functional design is relatively macroscopic and unchanging, and the adaptive design is relatively microscopic and needs to be adjusted according to an actual situation; the teacher adapts himself into a course based on the functional design, thereby generating and implementing a practical and feasible personalized private course;
S4, a SIV course design technology for interactions strategy of disciplinary schemata, which is configured to: digitize a course content development process; use a technology of thematic-concept-map to provide support for teachers and students to integrate, through interactive expansion, learning resources and SIV teaching strategies before, during and after class, and draw learning resources of a students' thematic-concept-map, a teachers' thematic-concept-map, and a students' expansion-thematic-concept-map that revolve around a core concept of the discipline bottlenecks; construct a learning field for interaction to achieve precise, deep, and extended discipline learning, thereby cultivating and enhancing discipline schematic thinking innovation ability of the students; and return, based on a 5P bead model, to the learning field to solve a problem of discipline innovation;
S5, a SIV strategy of technology design for critical interactions events, which is configured to: perform module format on an educational process, and calculate a consistency level between a design state and an operating state of an education system, wherein modules must be reusable and loosely coupled to avoid a change in one module from affecting multiple modules; determined, by adopting a combination of qualitative and quantitative evaluation module of critical interactions events, learners' abilities to achieve learning outcomes are evaluated. Thus thereby improving the project-based model design for the SIV cross-disciplinary theme; and
S6, an evaluation technology design for individual works of thematic-concept-map, which is configured to take, through a series of educational activities, students' personalized work from a flat map to a spatiotemporal four-dimensional design work, wherein the works of thematic-concept-map comprise presentation of the thematic-concept-map before class, educational drama interpretation of the thematic-concept-map during class, and presentation of discipline micro movies video work of the thematic-concept-map after class, and follow a rule of memory from a sensory memory input by external five senses to a first-order storage, a second-order storage and a third-order storage that lasts a lifetime; wherein multi-dimensional and orderly presentation and evaluation of the works effectively enhance high-level thinking abilities of teachers and students in various disciplines.

2. The schematic interactions visualization system for innovative education as claimed in claim 1, wherein the 5P bead model in S4 comprises phenomenon, problem, plan, prototype, and promotion.

3. The schematic interactions visualization system for innovative education as claimed in claim 1, wherein the learning field in S4 integrates acoustic medicine, cognition, emotion, and action, and has visibility, orderliness, artistry, and generativity.
